(19) United States
(12) Patent Application Publication
(10) Pub. No.: US 2004/0029759 A1
(43) Pub. Date: Feb. 12, 2004

(54) Method for cleaning in situ a textile material covering aircraft seats or floors and device and composition therefor

(76) Inventor: Michel Casiez, Evreux (FR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/415,882

(22) PCT Filed: Nov. 12, 2001
(86) PCT No.: PCT/FR01/03526

(30) Foreign Application Priority Data
Nov. 10, 2000 (FR) 00/14504

(51) Int. Cl. C11D 1/00

(52) U.S. Cl. 510/276

(57) ABSTRACT

The present invention concerns a method for on-site cleaning of a textile material covering notably airplane seats, or other support.

The method comprises the main following steps:

spraying a cleaning composition on the textile material by means of manual spraying of said composition et

clear water rinsing by injection-extraction by means of a rinsing device comprising a tub (3) containing water clear water and a spray-suction unit comprising a projection or injection pump (6) and a suction pump (8), connected to a working head (7).

The invention also concerns a device and a composition for the implementation of the method.

The present invention concerns an on-site cleaning method and its implementation device, applicable to a textile material covering notably airplane seats, but which may also cover any type of support such as automotive car seats or also a carpet covering the floor of the same plane, or still the floor of an exhibition hall or any other surface,

As regards more particularly the cleaning of airplane seats, besides quality and efficiency requirements, one encounters a particular problem which is due to the fast rotation thereof, which generally leaves little time for cleaning these seats as well as the covering of the floor, generally the carpet.

Fast operation is therefore desirable, which cannot be obtained with the conventional cleaning means, requiring the removal and the replacement of the seat covers.

It appears clearly that this leads to far too long cleaning times in the particular field of airplane cleaning.

Consequently, a large number of cleaning companies prefer, for more efficient cleaning, to remove the covers of all the seats systematically, for outside cleaning of the covers and putting clean seat covers.

Such process only remedies partially the shortcomings mentioned above since the intervention times are still too long even if reduced and, moreover, the seat covers may be damaged during removal or placement.

According to a first phase of the inventive approach, it has been contemplated to clean the airplane seats, as the case may be, without removing the covers thereof, and by means of electric, mechanical and chemical means, excluding any manual intervention for cleaning said seats.

To this end, the invention concerns a method for on-site cleaning of a textile material covering notably airplane seats, or other support.

According to the invention, the method comprises the main following steps:

spraying a cleaning composition on the textile material by means of a spraying pump and

clear water rinsing by injection-extraction by means, on the one hand, of a projection pump from a tub containing clear water and, on the other hand, of a suction pump extracting the water which has become soiled under the cleaning effect.

Thanks to the distribution of the cleaning method into two main phases, i.e. application of a cleaning composition with dissolution of the dirt, on the one hand, and extraction of the cleaning composition and of the dissolved dirt, on the other hand, the method of the invention enables to clean a textile material in a form which looks like the conventional washing and cleaning way as far as possible, without requiring the removal of the textile material from the support that it covers.

Indeed, a non-rinsed material after spreading a cleaning composition takes a very long time to dry. This is due to the fact that the active matters of the composition, when in contact with the ambient humidity, re-activate the product while promoting fast re-clogging.

The present invention also concerns the following features which will appear in the description below, and which must be considered individually or in all their technically possible combinations:

the water-diluted cleaning composition, in a predetermined percentage, is sprayed as a preparatory phase by means of an individual spraying device, followed by the clear water rinsing operation performed by the rinsing and suction unit;

a dust suction operation takes place before the spraying operation of the diluted cleaning composition, by means of the suction unit;

a brushing operation of any dirt, of various kinds, takes place before the clear water rinsing operation, using soft brushes;

a drying operation by extraction, until complete elimination of water on the textile support, is carried out by means of the suction unit.

The invention also concerns a device and a composition for the implementation of the method.

The description given hereunder for non limiting exemplification purposes, with reference to the appended drawings, states the way the invention can be realised.

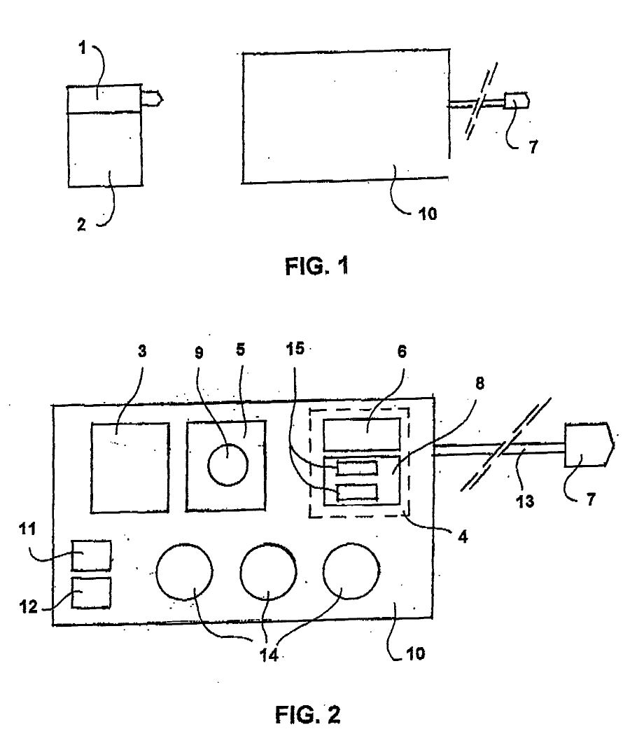

In these drawings, FIGS. 1 and 2 represent schematically both main steps of the cleaning method according to the invention and the elements of a device for its implementation.

The cleaning method of the invention comprises the main following steps:

spraying a cleaning composition on the textile material, by means of a spraying pump 1 and from a tub 2 containing said composition,

clear water rinsing by injection-extraction by means of a rinsing device comprising a tub 3 containing clear water and a spraying-suction unit 4.

The cleaning device of the invention comprises besides also a tub 5 for the collection of the water become soiled under the effect of the cleaning operation. The spraying-suction unit comprises a projection or injection pump 6 for pressurised pumping of the clear water towards a working head 7, as well as a suction pump 8 so that the soiled water can be sucked in by the working head 7.

Advantageously, the device also comprises a discharge pump 9 to direct the soiled water towards an external soiled water tub.

According to this embodiment, the cleaning composition and the clear water are sprayed by two distinct units. This brings essentially two advantages. The first consists in being able to use two units of very different designs. Thus, the spraying device of the cleaning composition may be a mobile unit enabling manual application of the cleaning composition. Such a unit may range, as regards its shape and its size, from a household product vaporiser or spray whereof the nozzle and the spraying mechanism are integrated to a head of the tank containing the cleaning composition, to a device having a separate tank to be carried, for example, on the back of the person performing the cleaning and a spraying lance connected to this tank by a flexible duct.

Conversely, the rinsing water is sprayed or projected and the soiled water is collected by a non-portable mobile unit to which the working head, through which the water is injected and sucked in, is connected by a long flexible.

However, if a particular application makes is advantageous, the cleaning device enabling the implementation of the on-site cleaning method according to the invention may also be designed in a unit shape then comprising, in a single unit, the means necessary to perform each of both main steps described above.

According to this embodiment, injection or projection of the clear water for rinsing the textile material and suction of the soiled water under the cleaning effect are performed by a mobile unit gathering, on a mobile plate 10, the tub 3 containing the clear water, the spraying-suction unit 4, the tub 5 for the collection of the soiled water, an electric connection and control unit 11 for power supply of the elements of the electrical mobile unit, with storag means 12, for example an electric cable winder, for storing the electric power supply cable, as well as a flexible duct 13 for the connection of the working head 7 to the spraying-suction unit 4 and storage means 14 for this flexible duct 13.

According to a variation mentioned above, the discharge pump 9 for directing the soiled water from the tub 5 towards an external soiled water tub is fixed in the bottom of the tub 5.

The flexible duct 13 may be designed in different fashions. First of all, the flexible duct 13 is composed advantageously of several sections which may be connected to one another by bayonet fittings or threaded fittings. Such a design is very particularly advantageous in the case of a mobile unit designed for cleaning an airplane. For such an application, the length of the flexible duct 13 may be greater than 50 m. FIG. 2 shows three storage tubs 14 for the case of a long duct 13 composed of several sections.

Similarly, taking into account the great length of the flexible duct 13, it may prove interesting to use a duct composed of two distinct channels, one for projection or spraying of the clear water and the other for suction and collection of the soiled water.

Finally, the working head 7 comprises at least one projection or spraying nozzle for the clear water and one suction nozzle for the soiled water and the dirt which may be sucked in simultaneously.

Preferably, prior to the spraying operation of the cleaning composition and to the injection-extraction operation of the rinsing water, a dust suction operation is carried out by means of the suction pump 8. To this end, the working head 7 may be replaced with a suction device.

There may also be brushing operation of any dirt, of various kinds, prior to the clear water rinsing operation, using soft brushes, for example by means of an electrical brush designed to be mounted instead of the working head 7.

In order to perfect this cleaning method, a drying operation by extraction, until complete elimination of the rinsing water on the support textile, is also carried out by means of the suction pump 8.

Advantageously, the tubs 3 and 5 are made of polypropylene or of stainless steel.

Preferably and for greater efficiency, the suction pump 8 is powered by two electric motors 15. These are preferably fin electrical motors of 1100 watt power operating under 220 volt enabling to obtain a 5000 mm depression.

As regards the flexible duct 13, it has been, for most applications, contemplated to use a length comprised between 20 and 60 m, once deployed, and it has a diameter of 38 mm in order to obtain, with the motors mentioned above, a depression of 5000 mm at its end.

It goes without saying that the number of motors and their respective power for the operation of the suction pump 8 may be adapted relative to the length of the flexible duct 13 in order to provide, at the exit of the suction nozzle of the working head 7, a depression of at least 5000 mm.

Accordingly, the motor of the spraying pump may be selected in relation to the duct or corresponding channel in these ducts, thereby directing the clear water to the corresponding spraying nozzle of the working head 7.

Besides, the electric motors may be of multi-power supply type in order to be able to operate on 220 Volts 50 Hz as well as on 110 Volts 60 Hz. In a variation, a transformer may also provide this multi-power supply.

Advantageously and according to another feature of the invention, all the elements necessary to the implementation of the rinsing phase of the on-site cleaning method according to the invention are arranged on the mobile plate 10 which, itself, constitutes the plate of a closed trailer in order to form a mobile and stand-alone cleaning unit, capable to be plugged to a fixed or mobile power supply source. According to the application, this fixed or mobile power supply unit may be either a stationary generator set, or the mains of a building or still an airplane mobile power supply set.

As regards the cleaning composition properly speaking for the implementation of the method by the device described above, said composition contains the following constitutive elements:

trisodic phosphate 12 H₂O of CAS 10101-89-0 type,

tetrasodic salt of tetra-acetate diamine ethylene acid of CAS 64-02-8 type,

nonyl phenol with 10 mol ethylene oxide of CAS 9016-45-9 type,

butyl glycol of CAS 111-76-2 type.

More accurately and according to a precise application embodiment, the composition contains the following constitutive elements:

trisodic phosphate 12 H₂O,

nonyl phenol with 10 mol ethylene oxide,

butyl glycol.

Good results have been recorded with the composition mentioned above, in the form of a concentrate which is diluted to 5-10% in water.

Optionally, a blue food colouring is added to said composition in the proportion.

The method and the device for its implementation and the cleaning composition used enable to obtain, according to the tests performed, perfect cleaning of the textile covering the seats and this in situ and quite rapidly, while ensuring the cleaning of the foam seat supports at the same time as the covers (covers which to this day have never been cleaned).

Another interest lies in that such results are obtained using a water supply stand-alone cleaning mobile unit which can be connected to different types of electric current.

Another advantage lies in that the extraction of the soiled water enables its collection in a tub specific for the collection of industrial waste for treatment purposes, without any fly tipping or to the sewage system.

Also, there is a significant reduction in weight of the materials and carpets after cleaning.

1. A method for on-site cleaning of a textile material covering notably airplane seats, or other support, characterised in that it comprises the main following steps:
spraying a cleaning composition on the textile material by means of manual spraying of said composition and
clear water rinsing by injection-extraction by means of a rinsing device comprising a tub (3) containing water clear water and a spray-suction unit comprising a projection or injection pump (6) and a suction pump (8), connected to a working head (7).

2. A method according to claim 1, characterised in that the cleaning composition (1) contains the following constitutive elements:
trisodic phosphate 12 H₂O,
tetrasodic salt of tetra-acetate diamine ethylene acid,
nonyl phenol with 10 mol ethylene oxide,
butyl glycol.

3. A method according to one of the claims 1 and 2, characterised in that a dust suction operation takes place before the spraying operation of the diluted cleaning composition, by means of an individual spraying device.

4. A method according to one of the claims 1 to 3, characterised in that a brushing operation of any dirt, of various kinds, takes place before the clear water rinsing operation, using soft brushes.

5. A method according to one of the claims 1 to 4, characterised in that a drying operation by extraction, until complete elimination of water on the textile support, is carried out by means of the suction pump (8).

6. A device for on-site cleaning of a textile material covering notably airplane seats or other support, characterised in that it comprises:
a spraying device (1) of a cleaning composition and
a rinsing device comprising:
a tub (3) containing clear rinsing water to be injected by an injection pump (6),
a suction pump (8) having at least one engine to extract the soiled water, and
a working head (7) connected to the injection (6) and suction (8) pumps by a flexible duct (13).

7. A device according to claim 6, characterised in that the rinsing device comprises a discharge pump (9) in order to evacuate this soiled water towards an external tub.

8. A device according to one of the claims 6 or 7, characterised in that the suction unit (5) is composed of two electric motors (15).

9. A device according to one of the claims 7 or 8, characterised in that all the clear rinsing water spraying, suction and soiled water discharge operations are performed by means of a flexible hose (13) connected to the spraying-suction unit (4).

10. A device according to one of the claims 6 to 9, characterised in that the whole assembly forming the rinsing device is arranged on the plate (10) of a trailer in order to form a mobile and stand-alone cleaning unit, capable to be plugged to a fixed or mobile power supply source.

11. A composition for the implementation of a method according to one of the claims 1 to 5 by the device according to one of the claims 6 to 10, characterised in that it contains the following constitutive elements:
trisodic phosphate 12 H₂O,
tetrasodic salt of tetra-acetate diamine ethylene acid,
nonyl phenol with 10 mol ethylene oxide,
butyl glycol.
